(19) United States
(12) Patent Application Publication
(10) Pub. No.: US 2007/0144244 A1
(43) Pub. Date: Jun. 28, 2007

(54) Probe module with integrated actuator for a probe microscope

(75) Inventor: David J. Ray, Agoura Hills, CA (US)

Correspondence Address: Sandra Lee Lipkin;A Professional Law Corporation, Suite 622, 1891 Goodyear Ave., Ventura, CA, 93003, US

(73) Assignee: Karma Technology, Inc.

(21) Appl. No.: 11/643,449

(22) Filed: Dec. 20, 2006

Related U.S. Application Data
(60) Provisional application No. 60/754,689, filed on Dec. 28, 2005.

(51) Int. Cl. G01N 13/10; G01N 13/12; G12B 21/20

(52) U.S. Cl. 73/105; 250/306; 250/307

(57) ABSTRACT

A scanning probe microscope comprises a probe module. In some embodiments the module is easily removed from the lateral and vertical scanning mechanisms. The module further comprises one or more vertical motion actuator that may be controlled by a multi-path feedback control loop. By coupling the second vertical motion actuator directly to the probe the speed of the scan may be increased over the speed of prior art microscopes. The feedback loop is part of the probe microscope and feedback paths may be independently designed to create independent control of multiple paths.

This application claims priority from U.S. Provisional Application No. 60/754,689, filed Dec. 28, 2005 the disclosure of which is hereby incorporated in its entirety for all purposes.

### FIELD OF THE INVENTION

The present invention relates generally to a scanning probe microscope and method for operating a scanning probe microscope. This invention more specifically relates to the motion of the probe in a direction substantially along an axis normal to the overall plane of the sample surface. The present invention also relates to the field of scanning probe microscopes, including those which use light beam detection schemes.

### BACKGROUND OF THE INVENTION

The following U.S. Patents are incorporated by reference in their entirety for all purposes:

U.S. Pat. No. 5,861,550, issued 19 Jan. 1999, to David J. Ray for SCANNING FORCE MICROSCOPE

U.S. Pat. No. 5,874,669, issued 23 Feb. 1999, to David J. Ray for SCANNING FORCE MICROSCOPE WITH REMOVABLE PROBE ILLUMINATOR ASSEMBLY

U.S. Pat. No. 6,138,503, issued 31 Oct. 2000, to David J. Ray for SCANNING PROBE MICROSCOPE SYSTEM INCLUDING REMOVABLE PROBE SENSOR ASSEMBLY

U.S. Pat. No. 6,189,373, issued 20 Feb. 2001, to David J. Ray for SCANNING FORCE MICROSCOPE AND METHOD FOR BEAM DETECTION AND ALIGNMENT

U.S. Pat. No. 6,415,654, issued 9 Jul. 2002, to David J. Ray for SCANNING PROBE MICROSCOPE SYSTEM INCLUDING REMOVABLE PROBE SENSOR ASSEMBLY

U.S. Pat. No. 6,748,794, issued 15 Jun. 2004, to David James Ray for METHOD FOR REPLACING A PROBE SENSOR ASSEMBLY ON A SCANNING PROBE MICROSCOPE

U.S. Pat. No. 6,910,368, issued 28 Jun. 2005, to David J. Ray for REMOVABLE PROBE SENSOR ASSEMBLY AND SCANNING PROBE MICROSCOPE

The prior art details the use of probe microscope systems for observing a sample surface. Many of these systems use a light beam often created by a laser wherein the beam is directed at a reflecting surface on the free end of a cantilever. A cantilever surface opposing the reflecting surface includes a probe tip that senses some parameter of the sample surface. If the probe tip experiences a force the cantilever will bend or deflect. The cantilever deflection may be either toward the sample surface if the force is attractive or away from the surface if the force is repulsive. The deflection may be measured by the beam of light as it is reflected from the reflecting surface of the cantilever. The position of the reflected beam may be determined by interposing an array of photo-detectors in the path of the reflected beam. Alternately, when a coherent light source is used, the deflection of the cantilever may be detected by an interference detector that compares the light phase of the reflected beam with the light phase of the original beam. A microscope that exploits the phenomenon of a force between the sample and the probe tip is commonly known as a Scanning Force Microscope.

If the forces detected are the inter-atomic forces between the atoms on the sample surface and the atoms of the probe tip, then the probe tip is typically shaped like and acts in the fashion of a stylus as it is moved over the sample surface. A microscope that uses this phenomenon is typically referred to as an Atomic Force Microscope.

Scanning force microscopes are members of a class of a broader category of microscopes known as scanning probe microscopes. Scanning probe microscopes may use a probe that senses some parameter of a sample such as topography, electric field strength, magnetic field strength, or surface charge density. A sensor will typically monitor a parameter of the probe tip and sample surface interaction, such as vertical forces acting on the tip or current flow from the tip to the sample surface. Scanning probe microscopes include scanning tunneling microscopes, scanning force microscopes, scanning capacitance microscopes, scanning thermal microscopes, and other types of probe microscopes. The probe is defined as any device that moves over or on the surface of the sample and detects a parameter either above, on or under the sample surface.

When used to image the topography of a sample, the scanning force microscope uses the finely pointed probe tip to interact with a sample surface. Scanning force microscope are typically used to measure the topography of recording media, polished glass, deposited thin films, polished metals and silicon wafers in preparation for integration into semi-conductor devices. A scanning mechanism in the microscope creates relative lateral and vertical motion between the probe tip and the sample surface. When a measurement of the interaction between the probe tip and surface is made, the measured data may be processed to reveal the surface topography of the sample in height as well as in the lateral dimensions. Other classes of probe microscopes may use different types of probes to measure sample features other than topography. For example, the interaction of a magnetic probe with the sample may produce data to create an image of the magnetic domains of the sample. Scanning tunneling microscopes use a conducting tip with a sharp point. A small bias voltage placed between the tip and the sample can cause a tunneling current to flow where the amount of current is a function of the tip to sample distance and the sample surface charge density. As the tip moves over the surface of the sample the resulting tunneling current at various locations on the sample surface is used to form an image of charge density on the surface of the sample.

In scanning force microscopes the combination of a probe tip, cantilever, and cantilever supporting elements may be referred to as a probe assembly. The cantilever has a cantilever force constant or spring constant that determines how far the cantilever will deflect or bend when the free end experiences a force. The cantilever may deflect noticeably when forces as small as one nano-Newton are applied to the free end. Typical cantilever force constant values for such cantilevers are in the range of 0.01 N/m to 48 N/m, where N is in Newtons and m is in meters. A detection mechanism is operatively connected to provide a signal proportional to cantilever deflection. This signal is then processed by a feedback loop to create a control signal. The control signal in turn drives a vertical actuator or drive mechanism. The vertical actuator moves the fixed end of the cantilever toward and away from the sample surface. In one mode of scanning this vertical actuator maintains the free end of the cantilever surface at a nearly constant bend angle, as detected by the detection mechanism. The vertical actuator accomplishes this by moving the probe assembly in proportion to the magnitude of the control signal. Alternately, the approximate position of the fixed end of the cantilever is maintained such that the cantilever noticeably deflects as the tip experiences forces generated between the sample surface and the tip. In this mode the signal generated by the detector changes as the cantilever deflects and these changing signals are used to determine the forces between the tip and sample.

As is commonly know in the prior art, the cantilever may be set into vibratory oscillation. As the probe is brought near the surface the oscillation parameters will change as the tip to sample surface forces begin to act on the cantilever through the tip. One or more of the oscillation parameters may be processed to create a control signal that maintains the oscillating probe at an average distance from the sample surface.

During scanning operation, a lateral drive mechanism creates relative lateral motion between the probe tip and sample. This relative lateral motion between the probe tip and the surface creates lateral and vertical forces on the tip as it interacts with surface features passing under the tip. The lateral force applies torque to the tip and cantilever. The vertical force on the tip causes the cantilever free end to deflect vertically. The known lateral position of the stylus over the sample can be expressed in terms of X and Y coordinates. The vertical deflection of the cantilever defines a height or Z value. The X and Y coordinates create a matrix of Z values which describe the surface topography of the sample. The scanning mechanism includes the vertical and lateral actuators.

In probe microscopes it is often necessary to replace the probe assembly. This may result from a blunted tip typically caused by wear of, or by small particles that adhere to, the tip as it scans over the sample. Also, the tip or the cantilever, or both can break, thus necessitating replacement of the probe assembly. When the probe assembly is replaced, the new cantilever often is not in the same position as the previous cantilever, relative to the laser and associated optics. Adjustment of either the light beam position or the probe assembly position is then required. Conventional alignment mechanisms restore the beam to its proper position on the reflecting surface of the cantilever and similar alignment mechanisms may also be used to reposition the detector into proper alignment with the reflected beam.

In order avoid costly down time for the microscope system the prior art describes a removable probe assembly as detailed in U.S. Pat. No. 5,874,669, U.S. Pat. No. 6,138,503, U.S. Pat. No. 6,189,373, U.S. Pat. No. 6,415,654, U.S. Pat. No. 6,748,794, and U.S. Pat. No. 6,910,368 all to Ray. These prior art devices permit probe replacement, beam alignment, and probe characterization all in an easily removable probe module. The replacement and alignment may be done off line and in a manner such that on a microscope used for process control the user need only replace the exhausted module with a fresh one and continue operation of the microscope.

While the replaceable probe module has these many advantages it warrants further improvement by including a provision for reducing the mass that is to be moved by the vertical actuator.

### SUMMARY OF THE INVENTION

As herein defined, the present invention in its first embodiment is a probe microscope for scanning a surface of a sample comprising means for creating relative motion between a removable probe module and the surface of the sample. The probe module further comprises a probe for sensing a parameter of said sample, means for creating relative motion between the probe and the sample, and detection means for detecting the response of the probe to the parameter of the sample.

The above embodiment can be further modified by further defining that the probe further comprises a tunneling tip that allows the microscope to create data as a result of a tunneling current.

The above embodiment can be further modified by further defining that the microscope is a scanning force microscope. The scanning force microscope further comprises a light source for creating a light beam, a detector to detect a reflection of the light beam, and a probe assembly. The probe assembly further comprises a cantilever and a tip supported by the cantilever.

The above embodiment can be further modified by further defining that the microscope further comprises a means for creating oscillatory motion of the cantilever.

The above embodiment can be further modified by further defining that the microscope further comprises a means for optical viewing of either the probe or the sample surface, or both. Such means includes one or more optical elements that have been selected from the group consisting of lenses, mirrors and prisms.

The above embodiment can be further modified by further defining that the microscope further comprises a first control circuit electrically coupled to the detection means and that controls the means for creating relative motion between the removable probe module and the sample and a second control circuit coupled to the detection means and that controls the means for creating relative motion between the probe and the sample.

The above embodiment can be further modified by further defining that the said light source is a laser.

The above embodiment can be further modified by further defining that the detection means is a light beam position detector.

The above embodiment can be further modified by further defining that the detection means is an interferometer.

A second embodiment of the invention is defined as a probe module for use in a probe microscope for scanning a surface of a sample. The probe module comprises a probe for sensing a parameter of the sample, one or more means for creating relative motion between the probe and the surface of the sample, and detection means for detecting the response of the probe to the parameter of the sample.

The second embodiment can be further modified by defining that the probe further comprises a tunneling tip that allows the microscope to create data as a result of a tunneling current.

The second embodiment can be further modified by defining that the module further comprises a light source for creating a light beam, a detector to detect a reflection of the light beam, and a probe assembly wherein the probe assembly further comprises a cantilever and a probe tip.

The second embodiment can be further modified by defining that the module further comprises a means for optical viewing of the probe and the sample surface, where such means includes one or more optical elements and where said optical elements are selected from the group consisting of lenses, mirrors and prisms.

The second embodiment can be further modified by defining that the microscope further comprises a control circuit electrically coupled to the detection means that controls one or more of the means for creating relative motion between the probe and the sample.

The second embodiment can be further modified by defining that the light source is a laser.

The second embodiment can be further modified by defining that the detection means is a light beam position detector.

The second embodiment can be further modified by defining that the detection means is an interferometer.

The second embodiment can be further modified by defining that there is a means to cause said cantilever to oscillate

The second embodiment can be further modified by defining that there is a means to detect a parameter of the cantilever oscillation.

The third embodiment of the invention is a method for scanning a sample using a probe microscope. The probe microscope has a removable probe module with the probe module having a probe. The method comprises the employment of a first means for creating relative probe module motion substantially toward and away from the sample, and the employment of a second means for creating relative probe assembly motion substantially toward and away from the sample wherein the second means is a part of the removable probe module.

The third embodiment can be further modified by defining that the probe module is a tunneling tip that allows the microscope to create data as a result of a tunneling current.

The third embodiment can be further modified by defining that the microscope is a scanning force microscope. The scanning force microscope further comprises a light source for creating a light beam, a detector to detect a reflection of the light beam, and a probe assembly that further comprises a cantilever and a tip.

The third embodiment can be further modified by defining that the microscope further comprises a means for optical viewing of the probe and the sample surface, where such means includes one or more optical elements and where said optical elements are selected from the group consisting of lenses, mirrors and prisms.

The third embodiment can be further modified by defining that the microscope further comprises control circuits electrically coupled to the detection means that controls each of the means for creating relative motion between the probe and the sample.

The third embodiment can be further modified by defining that the light source is a laser.

The third embodiment can be further modified by defining that the detector is a light beam position detector.

The third embodiment can be further modified by defining that the detector is an interferometer.

The fourth embodiment is defined as a control circuit for use with a scanning probe microscope wherein the control circuit is electrically coupled to a detection means and where the control circuit controls two or more means for creating relative motion between a probe and a sample.

The fourth embodiment can be further modified by defining that one or more functions of the control circuit are performed using digital signal processing.

The foregoing needs are meet to a great extent, by the present invention, wherein, in one embodiment the probe module assembly includes a vertical actuator connected directly to the probe assembly. The actuator is also connected to the module assembly and movement of the probe body relative to the module assembly is created by the actuator. The design of the actuator is such that it moves only the probe body, cantilever and tip.

In an alternate embodiment the microscope includes a secondary vertical actuator that moves the entire module in addition to the primary vertical actuator the moves only the probe.

In a further alternate embodiment the probe module also includes a photo-diode array for sensing position changes in the reflected light beam.

Other alternate embodiments reflect various locations for the primary vertical actuator and the lateral actuator relative to the probe module and sample.

Also disclosed is a variation of the invention for feedback control of multiple vertical actuators.

In the various embodiments it will be seen that vertical motion is imparted directly to the probe. Since the probe has relatively low mass the response of the probe to forces tending to cause changes in vertical height relative to the sample surface is exceptionally fast and the probe may be moved with exceptionally large vertical and lateral velocities. The beneficial improvements resulting from the current invention are scan times that are reduced dramatically over the scan time of prior art microscopes. In the various embodiments, the probe may be designed to detect magnetic force, electric force, or Van der Waals force. The probe may also detect thermal effects, near field optical effects, tunneling current, field effect current, or other parameters of the sample. The probe may also be used to determine surface elastic or plastic deformation of the surface.

### BRIEF DESCRIPTION OF THE DRAWINGS

FIG. 1 is a side view of a probe microscope assembly constructed with a first vertical actuator connected to a probe module.

FIG. 1A shows an array of photo-detectors.

FIG. 1B shows a probe assembly.

FIG. 1C shows a two layer flexure type piezo actuator.

FIG. 1D shows the two layer flexure actuator in a first alternate position.

FIG. 1E shows the two layer flexure in a second alternate position.

FIG. 1F shows a stack type piezo actuator.

FIG. 2 is a side view of a first alternate embodiment of a probe microscope with a single vertical actuator.

FIG. 3 is a side view, partially sectioned, of a second embodiment of a microscope assembly comprising a lateral and vertical actuator and a probe module comprising a second vertical actuator, a laser, a probe module, and a photo-detector.

FIG. 4 is a partially sectioned side view of a second alternate probe module showing a stacked type of vertical piezo-electric actuator.

FIG. 5 is a diagram of a probe microscope system using multiple feedback control for multiple vertical actuators.

FIG. 6 shows a third alternate embodiment of a probe microscope

FIG. 7 shows a fourth alternate embodiment of a probe microscope

FIG. 8 shows a fifth alternate embodiment of a probe microscope employing an interferometer.

FIG. 9 shows a sixth alternate embodiment of a probe microscope in the form of a tunneling microscope.

### DETAILED DESCRIPTION OF THE DRAWINGS AND PREFERRED EMBODIMENT

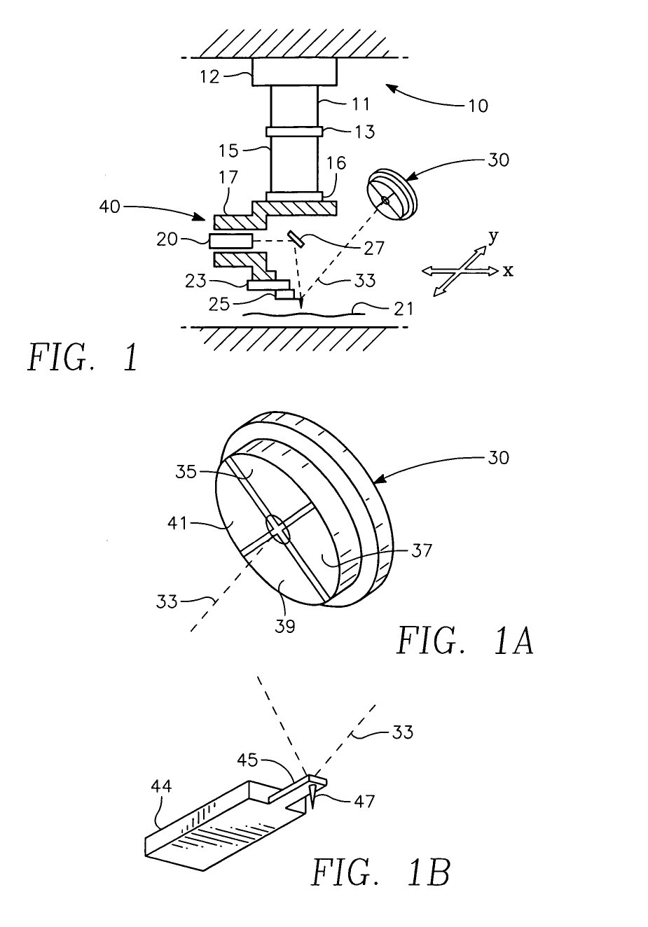

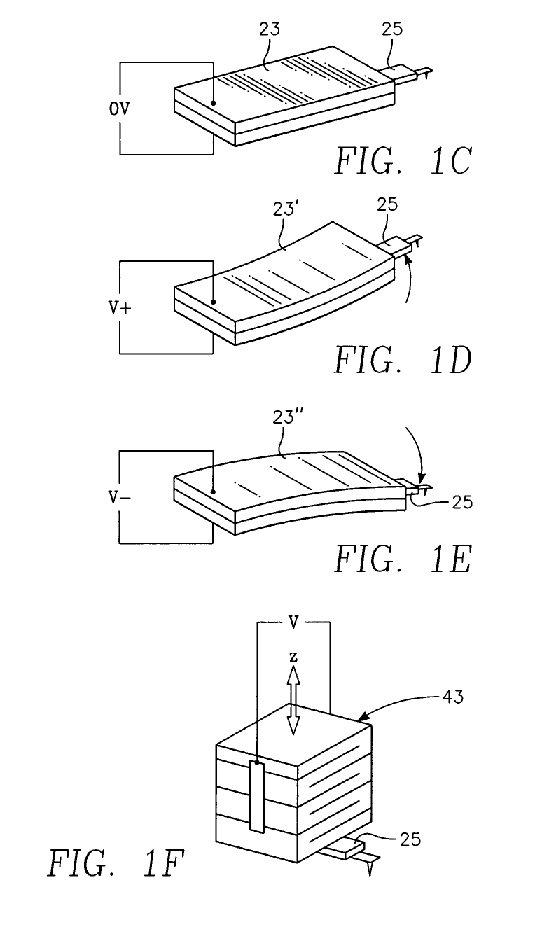

FIG. 1 is a partially sectioned side view of a probe microscope system 10. A coarse vertical actuator 12 is connected to a fixed reference frame on one side and connected to a lateral actuator 11 on the opposing side. Lateral actuator 11 is coupled to an adaptor ring 13 whose opposing side is coupled to a first vertical actuator 15. First vertical actuator 15 is coupled via a connect-disconnect device 16 to an easily removable probe module 40. Removable probe module 40 comprises a module housing 17, a light source 20, a second vertical actuator 23, and a probe assembly 25. Microscope system 10 also includes a light detector array 30. As shown in FIG. 1A, detector array 30 consists of an array of photo-detectors 35, 37, 39, 41. Referring back to FIG. 1 and to FIG. 1B, a mirror 27 reflects a light beam 33 emanating from light source 20, typically a laser, onto a cantilever 45 that is part of probe assembly 25. FIG. 1B details probe assembly 25. Assembly 25 comprises a probe body 44 and a tip 47 that are both coupled to cantilever 45. Probe body 44 is connected one end of cantilever 45. The end of cantilever 45 that is connected to probe body 44 is typically referred to as the constrained end. The opposed end of cantilever 45 that carries tip 47 is typically referred to as the free end.

FIGS. 1C, 1D, and 1E show second vertical actuator 23 in the form of a two layer flexure with attached probe assembly 25. In FIG. 1C vertical actuator 23 is activated by zero volts. In FIGS. 1D, and 1E, vertical actuator 23 is activated by plus voltage, and minus voltage and shown in alternate positions 23′ and 23″.

FIG. 1F shows a stack type piezo-ceramic vertical actuator 43 connected to probe assembly 25 and activated by voltage V.

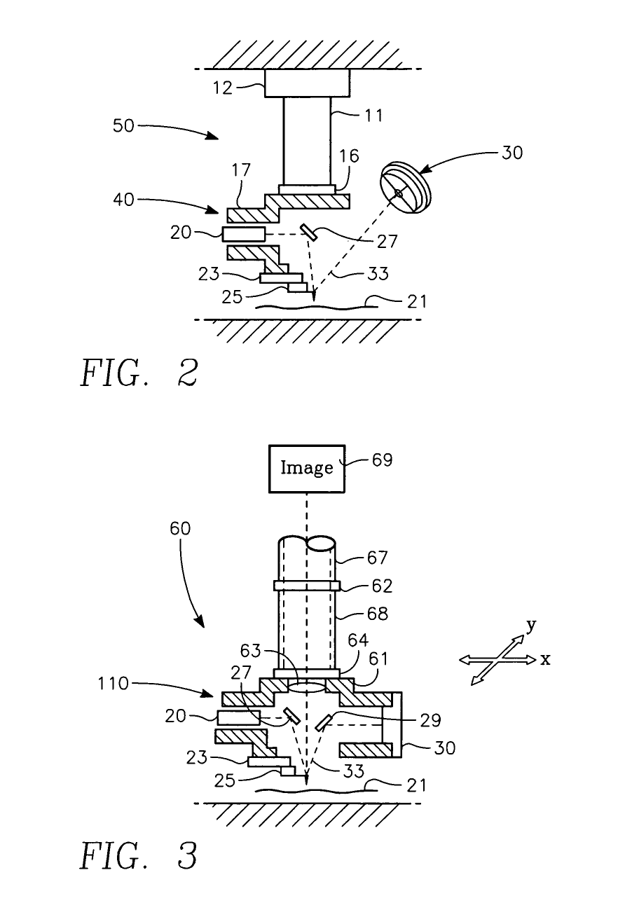

FIG. 2 shows a first alternate embodiment and shows lateral actuator 11 connected, on one side, directly to connect-disconnect 16 that is in turn connected to probe module 40. Probe module 40 comprises housing 17, light source 20, vertical actuator 23 and probe 25. Detector array 30 is part of alternate microscope assembly 50.

FIG. 3 is a second alternate embodiment and shows a partially sectioned side view of a second alternate microscope system 60 comprising a hollow lateral actuator 67 coupled, on one end, to a hollow adaptor ring 62 that is in turn coupled to a hollow vertical actuator 68. Actuator 68 is connected to a hollow connect-disconnect device 64 that is in turn coupled to an integral detector module 110. In this embodiment, module 110 comprises an alternate housing 61, light source 20 for creating light beam 33, second vertical actuator 23, probe assembly 25, mirror 27, a detector mirror 29, and detector array 30. Light beam 33 emanates from light source 20. In this embodiment the portion of light beam 33 reflected from probe assembly 25 is directed to detector array 30 by detector mirror 29. A lens 63 creates an optical image 69 of probe assembly 25 and sample surface 21.

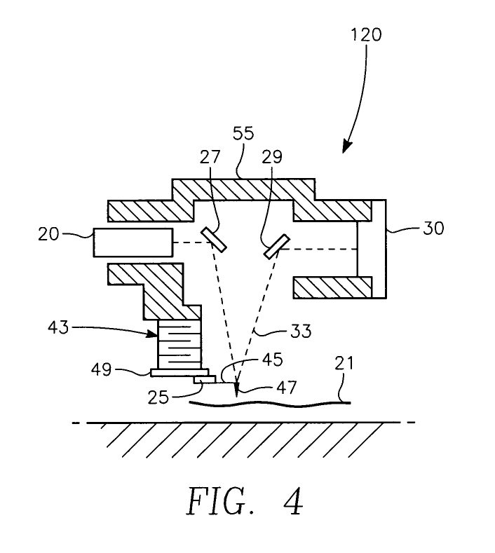

FIG. 4 shows a partially sectioned side view of an alternate probe module 120 comprising a stacked type piezo-electric actuator 43 connected on one end to an alternate module housing 55 and coupled on the opposing end to an adaptor plate 49. Probe assembly 25 is also coupled to adapter plate 49. Light source 20 is connected to housing 55. Source 20 creates light beam 33. Housing 55 is also connected to and carries mirror 27, and detector mirror 29, as well as array 30.

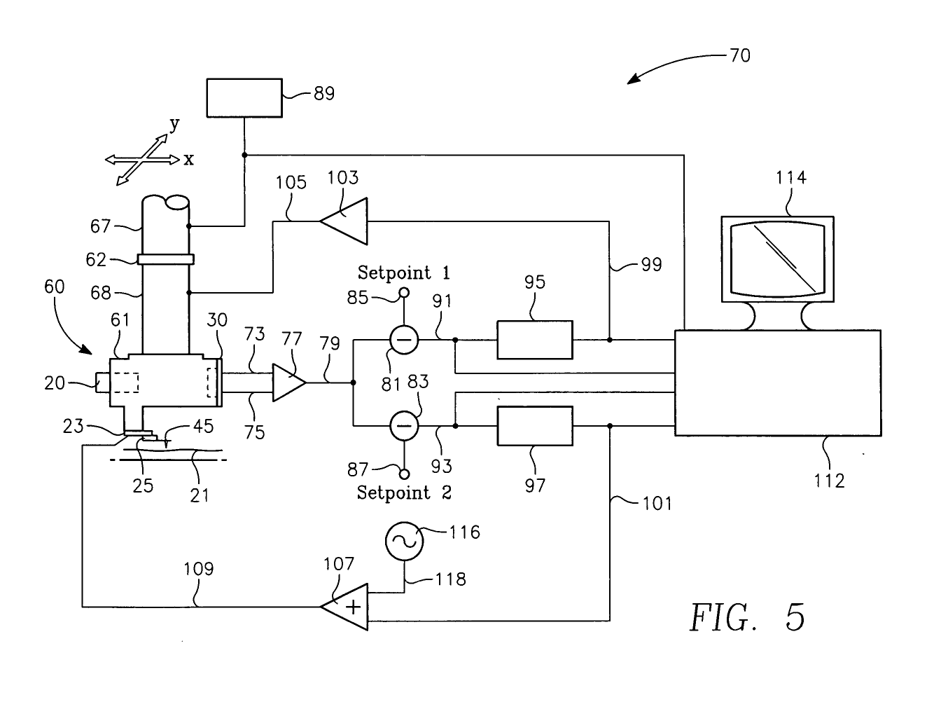

FIG. 5 is a block diagram of a feedback control system 70 for controlling either or both of the vertical actuators employed in either microscope system 10 or second alternate microscope system 60. Microscope system 60 is used as and example of how control system 70 would be employed and the numbered items of microscope system 60 may be identified by referring to FIG. 3. Detector array 30 communicates upper vertical signal 73 and lower vertical signal 75 to a difference amplifier 77. Signals 73 and 75 represent the vertical deflection of cantilever 45. Difference amplifier 77 communicates a position signal 79, also representative of the deflection of cantilever 45. Position signal 79 is further transmitted to a first summing junction 81 and a second summing junction 83. Junction 81 also receives a first setpoint value 85 and outputs a first error signal 91. Junction 83 receives a second set point value 87 and outputs a second error signal 93. First error signal 91 and second error signal 93 are routed to a first error processor 95 and a second error processor 97 respectively. First error processor 95 creates a first control signal 99 and second error processor 97 creates a second control signal 101. First and second control signals 99 and 101 are connected to a first actuator amplifier 103 and a second control amplifier 107 respectively. First actuator amplifier 103 creates a first amplified control signal 105 and second actuator amplifier creates a second amplified control signal 109. A vibration signal generator 116 generates an oscillatory signal 118 that is connected to second control amplifier 107. First and second control signals 99 and 101 are also routed to a computer 112. First and second error signals 91 and 93 may also be routed to computer 112. Computer 112 is connected to a display device 114. A generator 89 generates lateral signals in the X and Y directions and drives lateral actuator 11. The X and Y lateral position signals are reported by generator 89 to computer 112 for use in locating vertical data.

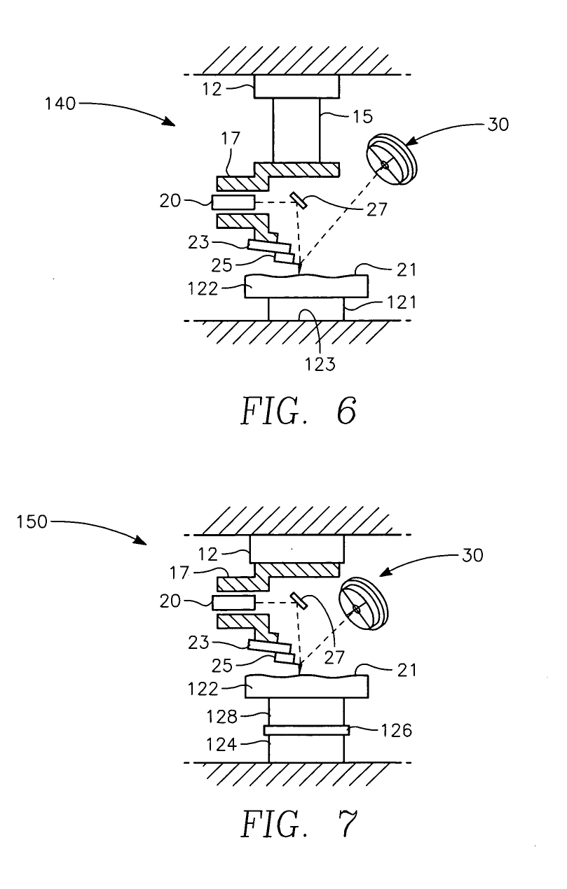

FIG. 6 shows a third alternate embodiment 140 of a probe microscope in which first vertical actuator 15 has one end connected to coarse vertical actuator 12. The opposing end of actuator 12 is connected to the fixed reference frame. Actuator 15 has its opposing end connected to module housing 17. Module housing 17 carries light source 20, second vertical actuator 23, probe assembly 25, mirror 27 and optionally photo-detector array 30. In this embodiment a sample 122 is carried on the free end of an alternate lateral actuator 121. Actuator 121 has an opposing end 123 connected to the same reference frame as the fixed end of coarse vertical actuator 12.

FIG. 7 shows a fourth alternate embodiment 150 of a probe microscope in which module housing 17 is connected to coarse vertical actuator 12 which is in turn connected to the fixed reference frame. In this embodiment probe assembly 25 is only moved by coarse actuator 12 and second vertical actuator 23. Sample 122 is mounted on an alternate first vertical actuator 128. Actuator 128 is coupled to an actuator coupler 126. The opposing side of actuator coupler 126 is connected to an alternate lateral actuator 124 and the opposing end of actuator 124 is connected to the fixed frame of reference.

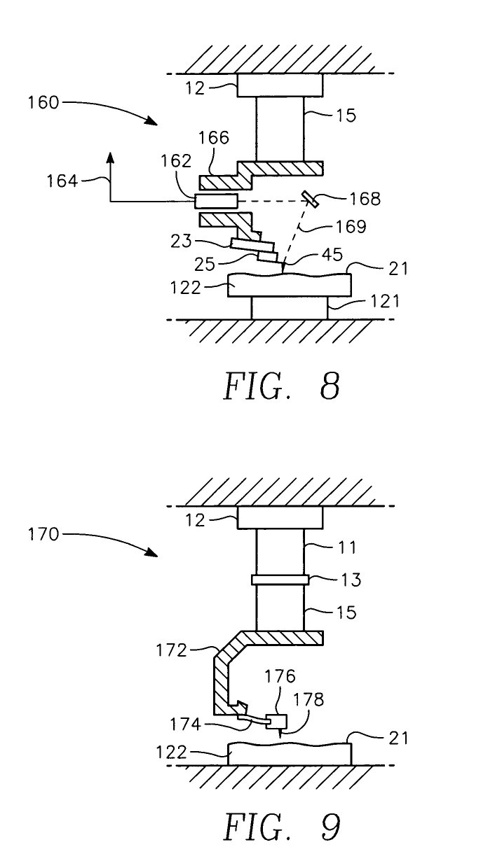

FIG. 8 shows a fifth alternate embodiment 160 of the present invention. An alternate probe support 166 is connected to one end of first vertical actuator 15. The opposed end of first vertical actuator 15 is connected to coarse vertical actuator 12. Support 166 supports an interferometer 162 and second vertical actuator 23. Actuator 23 in turn supports probe assembly 25. An interferometer mirror 168 directs an interferometer beam 169 to cantilever 45 and returns the reflected portion of beam 169 to interferometer 162. Sample 122 is connected to one end of alternate lateral actuator 121. Lateral actuator 121 has its opposing end connected to the fixed frame of reference.

FIG. 9 shows a sixth alternate embodiment 170 of the present invention. One end of lateral actuator 11 is connected to adapter ring 13 which is in turn connected to first vertical actuator 15. Actuator 15 is connected to an alternate module support 172. Alternate module support 172 carries an alternate second vertical actuator 174 which in turn is connected to a tunneling tip support 176. Tunneling tip support 176 supports a tunneling tip 178. Sample 122 is coupled to a fixed frame of reference.

### OPERATION

The operation of the microscope of the present invention may be understood by referring to FIG. 1. Upon command, lateral actuator 11 creates lateral motion in X and Y directions that are substantially parallel to the plane of sample surface 21. If lateral actuator 11 is of the piezo tube type the motion is actually a shallow arc in X and in Y resulting in combined motion that is an approximate shallow spherical surface over the sample surface 21. Alternately, lateral actuator 11 may consist of separate actuators for X and for Y (not shown) in which the motion at the end of the actuator 11 is more nearly a flat surface substantially parallel to sample surface 21.

In FIG. 1 vertical actuator 15 creates motion substantially normal to sample surface 21. Vertical actuator 15 is coupled to a probe module 40 via a connect-disconnect device 16. Device 16 allows for quick and easy connect and disconnect of probe module 40 from connect-disconnect device 16 and therefore relatively easy connect and disconnect of probe module 40 from microscope system 10. Probe assembly 25, moves vertically in response to first and second vertical actuators 15 and 23 and moves laterally in response to lateral actuator 11. As probe module 40 is moved over sample surface 21 it carries module housing 17, light source 20, mirror 27, second vertical actuator 23 and probe assembly 25. Light source 20 emits a light beam 33 such that light beam 33 reflects off mirror 27 toward probe assembly 25. Beam 33 then, at least partially, reflects off cantilever 45 toward detector array 30. Both actuator 15 and actuator 23 can provide motion substantially vertical to sample surface 21. In practice the total vertical motion of first and second actuators 15 and 23 are limited to micrometers. Thus, there is a need for coarse vertical actuator 12. Coarse vertical actuator 12 brings probe assembly 25 near enough to sample surface 21 such that vertical motion of first and second actuators 15 and 23 can follow sample surface 21 without exceeding their combined limited range.

In this embodiment detector array 30 is not part of probe module 40. As a result there is a slight error in the position of beam 33 as it strikes detector array 30 due to the relative lateral motion between probe assembly 25 and detector array 30. This error can be corrected by signal sensing electronics (not shown) for microscope system 10.

FIG. 1A provides detail about detector array 30. Four light sensitive diodes 35, 37, 39 and 41 are arranged in an array as shown. Light beam 33, is reflected from cantilever 45 as shown in FIG. 1B, and illuminates the diode array activating one or more of the photo-diodes. As beam 33 changes position due to the interaction of tip 47 and sample surface 21 the relative outputs of the individual diodes changes. Changes in the relative outputs are used by microscope system 10 as will be described later in FIG. 4.

FIG. 1B shows the detail of probe assembly 25. As tip 47 moves over sample surface 21 as described in FIG. 1 cantilever 45 will deflect or bend. The surface (not shown) of cantilever 45 opposite tip 47 is, at least, partially reflecting. As shown in, FIG. 1, light beam 33 is reflected off cantilever 45 and is redirected onto array 30. The redirection will change, as caused by the bending of cantilever 45, and causes light beam 33 to strike the detector array in a slightly different position, and the resulting different activation of detectors 35, 37, 39, and 41 will cause the outputs of detectors 35, 37, 39, and 41 to change. Probe assembly 25 is often manufactured using micro machining techniques.

FIG. 1C shows actuator 23 in which two layers of differently polarized piezo-electric material are connected. Such layered actuators are commonly referred to as two layer flexures or bimorph actuators. When zero voltage is applied across the different materials the actuator is substantially straight along its longer axis. Probe assembly 25 is attached to one end of the actuator and moves with the end of actuator 23.

FIG. 1D shows how, when actuator 23 has a positive voltage applied to the different piezo-electric elements, the free end will move upward as the upper element contracts and the lower element expands as seen in alternate position 23′.

FIG. 1E show actuator 23 with a negative voltage applied to the elements and how the free end with probe assembly 25 moves in a downward direction as seen in alternate position 23″.

While the previous figures have shown how vertical motion may be created with a two layer piezo-electric it is possible to create actuators with piezo-electric material layers in different configurations. FIG. 1F shows a stacked multi-element piezo-actuator 43. Actuator 43 operates by the expansion and contraction of the individual elements in the stack such that movement in the vertical direction is obtained. Probe assembly 25 may be coupled to stack piezo actuator 43 such that vertical motion of probe assembly 25 may be achieved by varying the voltage on the piezo-electric elements. Actuator 43 has the advantage of avoiding the shallow arc traced by the free end of two layer flexure actuator 23.

The operation of alternate microscope 50 shown in FIG. 2 will now be described. In this microscope lateral actuator 11 is coupled directly to connect-disconnect device 16 allowing for quick and easy connect and disconnect of probe module 40 from lateral actuator 11. In this embodiment and when in scanning operation actuator 23 is the single source of vertical motion of probe assembly 25 relative to sample surface 21. The operation is otherwise similar to the microscope system described in FIG. 1 but in this embodiment only vertical actuator 23 is operative in the Z direction during scanning operation.

The operation of second alternate microscope system 60 shown in FIG. 3 will now be described. Hollow lateral actuator 67 creates lateral motion in orthogonal X and Y directions substantially parallel to the plane of sample surface 21. This motion is transferred to hollow ring 62, to hollow vertical actuator 68, to hollow connect-disconnect device 64, and to integral detector module 110. Vertical actuator 68 creates motion substantially normal to average plane of sample surface 21. This motion is also transferred to module 110 in the same manner as described for the lateral motion created by lateral actuator 67. The motion imparted to module 110 is also imparted to housing 61, light source 20, to detector array 30, to mirror 27 and detector mirror 29, as well as to second vertical actuator 23 and to probe assembly 25. As probe assembly 25 is moved laterally over sample surface 21, cantilever 45 will deflect as tip 47 experiences forces interacting between tip 47 and sample surface 21. Detector array 30 detects the change in position of light beam 33 resulting from the deflection of cantilever 45. Hollow actuator 68 and second vertical actuator 23 may be used in conjunction with the feedback system described in FIG. 4 to maintain a consistent preset bend angle of cantilever 45.

In this embodiment lens 63 is positioned above probe assembly 25 and allows viewing of sample surface 21 through hollow ring 62, hollow connect-disconnect device 64, hollow lateral actuator 67 and hollow vertical actuator 68. Image 69 is formed by lens 63 on the Z axis and above lateral actuator 67.

The operation of alternate probe module 120 in FIG. 4 will now be described. In this embodiment, module 120 employs a stacked type piezo-electric actuator 43 coupled to an adaptor plate 49. Probe assembly 25 is coupled to the opposing end of adapter plate 49. Consequently, when alternate probe module 120 moves, the result is that each constituent part of module 120 moves with the same motion as imparted to module 120. Since stack actuator 43 moves substantially in a vertical direction without swinging through a shallow arc, the vertical motion with actuator 43, during scanning operation, is substantially normal to the average plane of sample surface 21. Light beam 33 created by light source 20 reflects off mirror 27 and onto probe assembly 25, back to detector mirror 29 and onto detector array 30. As probe assembly 25 moves relative the sample surface 21, tip 47 will experience forces created by sample surface 21. These forces will cause cantilever 45 to deflect and change the position of beam 33 on detector array 30.

Referring to FIG. 5 the operation of feedback control system 70 will now be described. In the foregoing descriptions of the operation microscope 10 and second alternate microscope system 60 it is clear that since two vertical actuators are employed, a system of controlling two or more vertical actuators must be employed. System 70 may be used to control either or both of the vertical actuators employed in either microscope systems 10 and second alternate microscope system 60. Microscope system 60 is used as an example of how control system 70 would be employed with the numbered items of microscope system 60 where the items may be identified by referring to FIG. 3. Microscope system 10 as well as other embodiments also use two vertical actuators and may be similarly connected to control system 70.

Detector array 30 generates signals that are processed by electronic circuits (not shown) to create signals 73 and 75 to signal the location of light beam 33 on detector array 30. Difference amplifier 77 creates a vertical location signal 79 that is in turn routed to first summing junction 81 and second summing junction 83. First junction 81 subtracts first setpoint 85 from signal 79. Second junction 83 subtracts second setpoint 87 from signal 79. By combining signal 79 with first setpoint 85 and with appropriate attention to polarity, junction 81 creates first error signal 91. Similarly, with proper attention to signal polarity, junction 83 creates second error signal 93 by combining signal 79 with second setpoint 87.

Error signal 91 is routed to an error processor 95. Error processor 95 outputs a first control signal 99 noted here as C₁ where signal 99 is determined as a function f₁ of error signal 91 noted here as E₁ and mathematically expressed as follows:
C₁=f₁(E₁).

Similarly, error processor 97 outputs second control signal 101 noted here as C₂. First control signal 101 is determined as a function f₂ of error signal 93 noted here as E₂ and mathematically expressed as follows:
C₂=f₂(E₂).

Control signal 99 may be routed to an amplifier 103. Amplifier 103 sets the proper gain for signal 99 and may also introduce an offset if required to produce first amplified control signal 105 thus causing actuator 68 to expand or contract as desired. Similarly, second control signal 101 may be routed to amplifier 107 where amplifier 107 applies the proper gain to create second amplified control signal 109. Amplifier 107 may also introduce an offset in signal 109. Signal 109 may cause second actuator 23 to move probe assembly 25 toward or away from sample surface 21 as required. First and second control signals 99 and 101 are processed by computer 112 and the resulting images or data are displayed on display device 114. Alternately, or additionally first and second error signals 91 and 93 may also be processed with or without first and second control signals 99 and 101 to create the desired data for display on display device 114. A generator 89 generates lateral signals in the X and Y directions and drives lateral actuator 67. The X and Y lateral position signals are reported by generator 89 to computer 112 for use in locating the vertical data.

Vibration signal generator 116 generates an oscillating signal 118. As a result cantilever 45 will then be set into oscillatory motion. A demodulator circuit (not shown) may be incorporated into amplifier 77 and the demodulated signal may be optionally incorporated into position signal 79.

Data created by computer 112 may also be stored in memory (not shown) and or sent to satellite computers and displays (not shown) for process control or display.

In some instances it may also be desirable to introduced additional vertical actuators and control circuits to probe microscopes. Consequently, additional actuators and circuits may be added by splitting signal 79 into three or more paths and routing the paths to additional summing junctions and error processing circuits.

The signal processing described may take place as all analog, all digital, or a combination of analog and digital signal processing.

First and second error signals 91 and 93 may be created from a varying direct current, a varying dc voltage, or a varying ac voltage signal contained in signal 79. The error signal may also be created from a varying alternating current parameter such as varying amplitude, varying phase, or varying frequency contained in signal 79.

In addition the multi-path feedback circuit using multiple actuators described herein may by used on any type of probe microscope that requires control in a specific direction.

The operation of the probe microscope system shown in FIG. 6 will now be described. For the purpose of bringing probe assembly 25 within the combined limited range of first and second vertical actuators 15 and 23, coarse vertical actuator 12 creates coarse motion in the vertical direction to bring probe assembly 25 into proximity to sample surface 21. Vertical actuator 15 is again used to create relative vertical motion between probe assembly 25 and sample surface 21. This is accomplished by the connection of module housing 17 with vertical actuator 15. Further, light source 20, mirror 27, and second vertical actuator 23, as well as probe assembly 25 will move vertically as well due to the connection of each of these with housing 17. In addition, second vertical actuator 23 will also create relative vertical motion between housing 17 and sample surface 21. Relative lateral motion between sample surface 21 and probe assembly 25 is created by mounting sample 122 on one end of alternate lateral actuator 121. The opposing side of lateral actuator 121 is connected to the fixed frame of reference.

The operation of the probe microscope system shown in FIG. 7 will now be described. For the purpose of bringing probe assembly 25 within the combined limited range of first and second vertical actuators 15 and 23, coarse vertical actuator 12 creates coarse motion in the vertical direction to bring probe assembly 25 into proximity to sample surface 21. Module housing 17 and its constituent components composed of light source 20, mirror 27, second vertical actuator 23, and probe assembly 25 do not move laterally. Sample 122 however, is mounted to alternate first vertical actuator 128 and via actuator coupler 126, to alternate lateral actuator 124. Consequently, sample 122 moves both laterally and vertically. Since both alternate first vertical actuator 124 and second vertical actuator 23 create relative vertical motion between probe assembly 25 and sample surface 21 both second vertical actuator 25 and alternate first vertical actuator 128 can be placed under feedback control as described in the operation of FIG. 4.

The operation of the probe microscope system shown in FIG. 8 will now be described. Coarse vertical actuator 12 brings probe assembly into proximity with sample surface 21. Vertical actuator 15 creates vertical motion between coarse vertical actuator 12 and alternate probe support 166. When alternate probe support 166 moves, its coupled constituent components, consisting of mirror 168, second vertical actuator 23, and probe assembly 25, also move. Since probe support 166 also carries interferometer 162, interferometer 162 will move vertically as well. Sample 122 is coupled to one side of lateral actuator 121 and as a consequence relative lateral motion between sample surface 21 and probe assembly 25 is created.

Interferometer 162 emits light beam 169 that is reflected from mirror 168 onto cantilever 45. Since cantilever 45 is at least partially reflecting, a portion of beam 169 returns via mirror 168 to interferometer 162. Interferometer 162 then outputs an electrical signal via a conductor or conductors 164. The output signal may then be used to create feedback signals as described in FIG. 4.

The operation of the probe microscope system 170 shown in FIG. 9 will now be described. Coarse vertical actuator 12 brings probe assembly 25 into proximity with sample surface 21. Lateral actuator 11 creates relative lateral motion between tunneling tip 178 and sample surface 21. This is accomplished when actuator 11 laterally moves adapter ring 13, first vertical actuator 15 and alternate module support 172. Module support 172 in turn laterally moves alternate second vertical actuator 174, tunneling tip support 176 and tunneling tip 178. First vertical actuator 15 and alternate second vertical actuator 174 also create relative vertical movement between tunneling tip 178 and sample surface 21. Either one or both of first and second vertical actuators 15 and 174 may be controlled by a feedback signal or signals as shown in FIG. 4.

The many features and advantages of the invention are apparent from the detailed specification, and thus, it is intended by the appended claims to cover all such features and advantages of the invention, which fall within the true spirit, and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A probe microscope for scanning a surface of a sample comprising
means for creating relative motion between a removable probe module and said surface of said sample whereby said probe module further comprises
a probe for sensing a parameter of said sample;
means for creating relative motion between said probe and said sample; and
detection means for detecting the response of said probe to said parameter of said sample.

2. A probe microscope as defined in claim 1 wherein said probe further comprises a tunneling tip that allows said microscope to create data as a result of a tunneling current.

3. A probe microscope as defined in claim 1 wherein said microscope is a scanning force microscope, said scanning force microscope further comprising
a light source for creating a light beam;
a detector to detect a reflection of said light beam;
a probe assembly wherein said probe assembly further comprises
a cantilever; and
a tip supported by said cantilever.

4. A probe microscope as defined in claim 3 wherein said microscope further comprises a means for creating oscillatory motion of said cantilever.

5. A probe microscope as defined in claim 1 wherein said microscope further comprises a means for optical viewing of said probe or said sample surface, where such means includes one or more optical elements and where said optical elements have been selected from the group consisting of lenses, mirrors and prisms.

6. A probe microscope as defined in claim 1 wherein said microscope further comprises a first control circuit electrically coupled to said detection means and that controls said means for creating relative motion between said removable probe module and said sample and a second control circuit coupled to said detection means and that controls said means for creating relative motion between said probe and said sample.

7. A probe microscope as defined in claim 3 wherein said light source is a laser.

8. A probe microscope as defined in claim 1 wherein said detection means is a light beam position detector.

9. A probe microscope as defined in claim 1 wherein said detection means is an interferometer.

10. A probe module for use in a probe microscope for scanning a surface of a sample whereby said probe module comprises
a probe for sensing a parameter of said sample;
one or more means for creating relative motion between said probe and said surface of said sample; and
detection means for detecting the response of said probe to said parameter of said sample.

11. A probe module as defined in claim 10 wherein said probe further comprises a tunneling tip that allows said microscope to create data as a result of a tunneling current.

12. A probe module as defined in claim 10 wherein said module further comprises
a light source for creating a light beam;
a detector to detect a reflection of said light beam;
a probe assembly wherein said probe assembly further comprises
a cantilever; and
a probe tip.

13. A probe module as defined in claim 10 wherein said module further comprises a means for optical viewing of said probe and said sample surface, where such means includes one or more optical elements and where said optical elements being selected from the group consisting of lenses, mirrors and prisms.

14. A probe module as defined in claim 10 for use in a probe microscope wherein said microscope further comprises a control circuit electrically coupled to said detection means that controls one or more of said means for creating relative motion between said probe and said sample.

15. A probe module as defined in claim 12 wherein said light source is a laser.

16. A probe microscope as defined in claim 10 wherein said detection means is a light beam position detector.

17. A probe microscope as defined in claim 10 wherein said detection means is an interferometer.

18. A probe microscope as defined in claim 12 wherein there is a means to cause said cantilever to oscillate

19. A probe microscope as defined in claim 18 wherein there is a means to detect a parameter of said cantilever oscillation.

20. A method for scanning a sample using a probe microscope, said probe microscope having a removable probe module, said probe module having a probe, said method further comprising
employing a first means for creating relative probe module motion substantially toward and away from said sample; and
employing a second means for creating relative probe motion substantially toward and away from said sample wherein said second means is a part of said removable probe module.

21. A method as defined in claim 20 wherein said probe module is a tunneling tip that allows said microscope to create data as a result of a tunneling current.

22. A method as defined in claim 20 wherein said microscope is a scanning force microscope, said scanning force microscope further comprising
a light source for creating a light beam;
a detector to detect a reflection of said light beam;
a probe assembly wherein said probe assembly further comprises
a cantilever; and
a tip.

23. A method as defined in claim 20 wherein said microscope further comprises a means for optical viewing of said probe and said sample surface, where such means includes one or more optical elements and where said optical elements being selected from the group consisting of lenses, mirrors and prisms.

24. A method as defined in claim 20 wherein said microscope further comprises control circuits electrically coupled to said detection means that controls each of said means for creating relative motion between said probe and said sample.

25. A method as defined in claim 22 wherein said light source is a laser.

26. A method as defined in claim 22 wherein said detector is a light beam position detector.

27. A method as defined in claim 20 wherein said detector is an interferometer.

28. A control circuit for use with a scanning probe microscope wherein said control circuit is electrically coupled to a detection means and where said control circuit controls two or more means for creating relative motion between a probe and a sample.

29. The control circuit as defined in claim 28 where one or more functions of said control circuit are performed using digital signal processing.
